(19) United States
(12) Patent Application Publication
(10) Pub. No.: US 2018/0329492 A1
(43) Pub. Date: Nov. 15, 2018

(54) PARALLAX CORRECTION FOR TOUCH-SCREEN DISPLAY

(71) Applicant: Microsoft Technology Licensing, LLC, Redmond, WA (US)

(72) Inventors: Justin Allan COPPIN, Fort Collins, CO (US); Uri RON, Kfar Saba (IL); Paul William MARTIN, Loveland, CO (US); On HARAN, Kfar Saba (IL); Michael ORLOVSKY, Hod HaSharon (IL)

(73) Assignee: Microsoft Technology Licensing, LLC, Redmond, WA (US)

(21) Appl. No.: 15/590,822

(22) Filed: May 9, 2017

(51) Int. Cl. G06F 3/01; G06F 3/041; G06F 3/0488; G06F 3/0481

(52) U.S. Cl. CPC G06F 3/015; G06F 3/013; G06F 3/0418; G06F 3/033; G06F 3/04812; G06F 3/04886; G06F 3/04883

(57) ABSTRACT

A touch-sensing display system comprises a contactable display surface in addition to touch-screen, pupil-estimation, user-pointer, and display logic. The touch-screen logic is configured to sense normal coordinates directly behind a point of the user contact on the contactable display surface. The pupil-estimation logic is configured to estimate the vantage vector pointing from the vantage point of the user and through the point of user contact. The user-pointer logic is configured to compute adjusted coordinates of the contactable display surface, the adjusted coordinates being shifted from the normal coordinates based on the estimated vantage vector. The display logic is configured to render a visible feature on the contactable display surface at the adjusted coordinates.

### BACKGROUND

The touch-screen display is a state-of-the-art user-interface (UI) modality for various electronic devices. Touch-screen display technology may employ resistive, capacitive, or optical touch sensing, for example. Of these variants, capacitive touch sensing is especially suitable for multi-touch tracking on modern liquid-crystal and organic light-emitting diode (OLED) displays. A capacitive touch screen reliably tracks contact from one or more fingers of a user or from a stylus held in the user's hand. In contrast to a passive stylus, which mimics the capacitive coupling of the user's finger on the touch screen, an active stylus employs active charge-sensing and charge-injection to reduce latency and enable more precise sensing of the touch point. No matter how precisely the touch point is sensed, however, optical parallax that the experiences on sighting the tip of a stylus may create an illusion of tracking error. This effect may be frustrating to the user and may degrade the overall UI experience.

### SUMMARY

This disclosure is directed in part to a touch-sensing display system comprising a contactable display surface in addition to touch-screen, pupil-estimation, user-pointer, and display logic. The touch-screen logic is configured to sense normal coordinates directly behind a point of the user contact on the contactable display surface. The pupil-estimation logic is configured to estimate the vantage vector pointing from the vantage point of the user and through the point of user contact. The user-pointer logic is configured to compute adjusted coordinates of the contactable display surface, the adjusted coordinates being shifted from the normal coordinates based on the estimated vantage vector. The display logic is configured to render a visible feature on the contactable display surface at the adjusted coordinates.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example touch-screen display device.

FIG. 2 shows aspects of an example capacitive touch screen.

FIG. 3 shows aspects of an example active stylus associated with a capacitive touch-screen.

FIG. 4 is a schematic representation of a touch-screen display device as a series of stacked layers.

FIGS. 5A and 5B schematically illustrate the geometrical basis of positioning error due to optical parallax.

FIG. 6 illustrates some aspects of pupil estimation on an example touch-screen display device.

FIG. 7 shows additional aspects of the example touch-screen display device of FIG. 1.

FIGS. 8 and 9 illustrate example methods of user-pointer adjustment and positioning-error correction.

### DETAILED DESCRIPTION

Positioning the tip of a ballpoint pen at a predetermined location on a piece of paper is trivial for most people. In contrast, placing a stylus tip at a predetermined location on a touch-screen display is not trivial, for the intended point of contact is often missed. As noted above, error in positioning the stylus tip on the touch-screen display may be perceived by the user as a precision defect of the display. In a well-calibrated system, however, most of the positioning error may actually be due to optical parallax that the user perceives because the light-emitting plane of the display is separated from the contactable display surface in front of it. Described herein is a series of approaches to remedy the problem of optical parallax for touch-screen display users. The remedy is intended to provide a more satisfying and intuitive UI experience, akin to touching pen to paper.

Aspects of this disclosure will now be described by example, and with reference to the drawing figures listed above. Components, process steps, and other elements that may be substantially the same in one or more embodiments are identified coordinately and described with minimal repetition. It will be noted, however, that elements identified coordinately may also differ to some degree. It will be further noted that the drawing figures are schematic and generally not drawn to scale. Rather, the various drawing scales, aspect ratios, and numbers of components shown in the figures may be purposely distorted to make certain features or relationships easier to see.

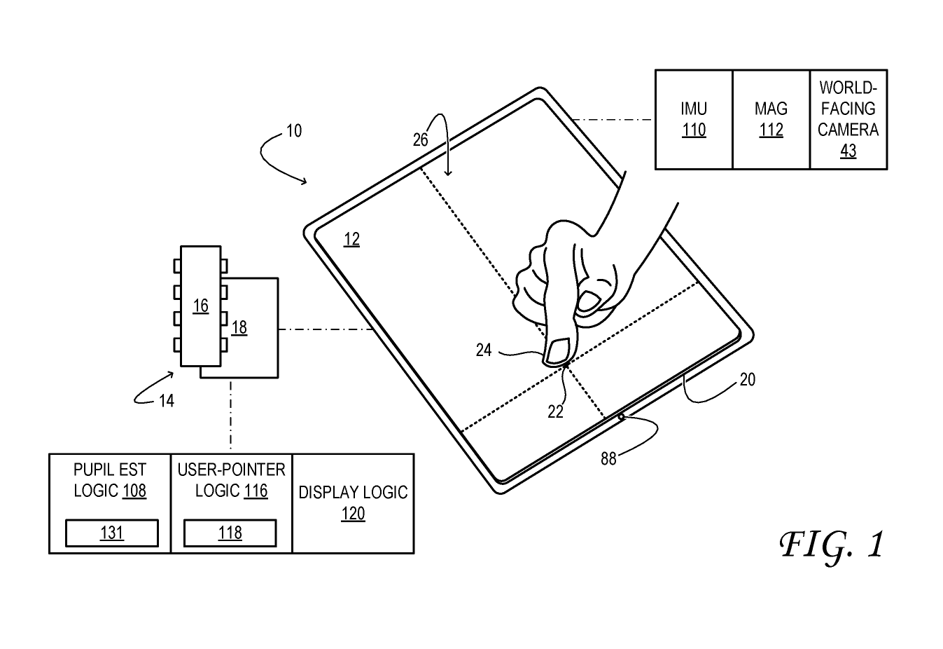

Prior to addressing the problem of optical parallax on a touch-screen display device, an example touch-sensing display system will first be described. It should be understood, however, that the solutions presented herein are equally applicable to various other touch-sensing display systems. FIG. 1 shows aspects of an example touch-screen display device 10 including a capacitive touch screen 12. In the illustrated example, the touch-screen display device is a tablet computer system: it includes an integrated computer 14 comprising at least one processor 16 and associated computer memory 18. The computer memory holds instructions that cause the processor to enact the various methods disclosed herein. Touch-screen display device 10 is one example of a touch-sensing display system, which may also include a passive or active stylus (vide infra). In other examples, the touch-screen display device may take the form of a smartphone, computer monitor, stand-alone touch-input system, or virtually any other touch-screen display device.

In the embodiment of FIG. 1, capacitive touch screen 12 is arranged in front of a liquid crystal display (LCD) 20. In other embodiments, the touch screen may be arranged in front of a light-emitting diode (LED) display, an organic LED (OLED) display, a scanned-beam display, or any other kind of display. Touch screen 12 is configured to sense one or more touch points 22 effected by a user. One example touch point is the point of contact between the user's fingertip 24 and the contactable display surface 26 of the touch screen.

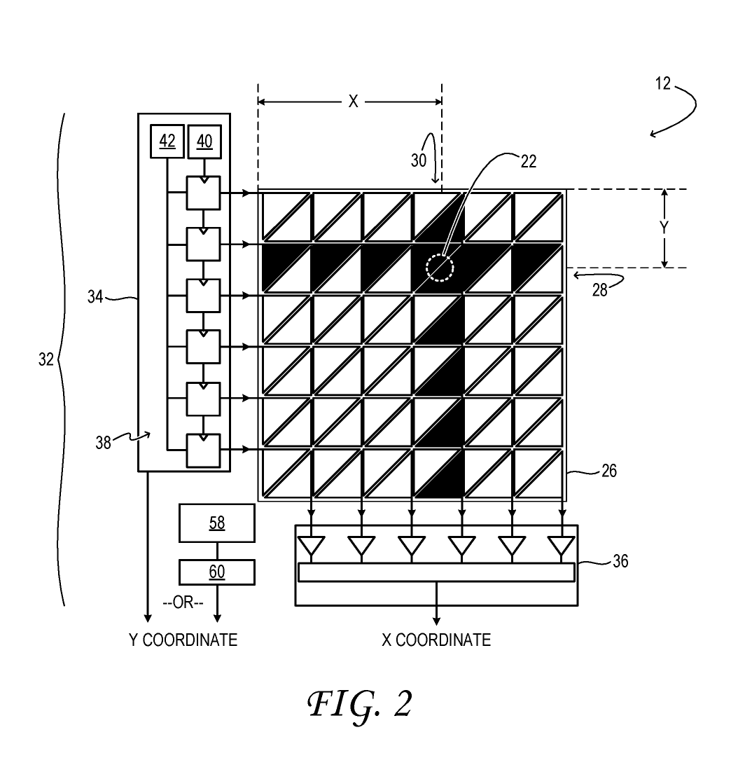

FIG. 2 shows additional aspects of touch screen 12 in one example embodiment. Arranged on contactable display surface 26 is a series of row electrodes 28 and a series of column electrodes 30. Touch screens here contemplated may include any number N of row electrodes and any number M of column electrodes. Although it is customary to have the row electrodes aligned horizontally and the column electrodes aligned vertically, this aspect is in no way necessary: as the terms ‘row’ and ‘column’ may be exchanged everywhere in this description. Continuing, the row and column electrodes of the touch screen are addressed by touch-screen logic 32. The touch-screen logic is configured to sense user contact on the contactable display surface, including normal coordinates directly behind a point of user contact of a finger or stylus on the contactable display surface. To that end, the touch-screen logic includes row-driver logic 34, column-sense logic 36, and other componentry to be described hereinafter.

Column-sense logic 36 includes M column amplifiers, each coupled to a corresponding column electrode 30. Row-driver logic 34 includes a row counter 38 in the form of an N-bit shift register with outputs driving each of N row electrodes 28. The row counter is clocked by row-driver clock 40. The row counter includes a blanking input to temporarily force all output values to zero independent of the values stored. Excitation of one or many rows may be provided by filling the row counter with ones at every output to be excited, and zeroes elsewhere, and then toggling the blanking signal with the desired modulation from modulation clock 42. In the illustrated embodiment, the output voltage may take on only two values, corresponding to the one or zero held in each bit of the row counter; in other embodiments, the output voltage may take on a greater range of values, to reduce the harmonic content of the output waveforms, or to decrease radiated emissions, for example.

Row-driver logic 34 applies an excitation pulse to each row electrode 28 in sequence. During a period in which contactable display surface 26 is untouched, none of the column amplifiers registers an above-threshold output. However, when the user places a fingertip on the contactable display surface, the fingertip capacitively couples one or more row electrodes 28 intersecting the touch point 22 to one or more column electrodes 30 also intersecting the touch point. The capacitive coupling induces an above-threshold signal from the column amplifiers associated with the column electrodes beneath (i.e., adjacent) the touch point, which provides sensing of the touch point. Column-sense logic 36 returns, as the X coordinate of the touch point, the numeric value of the column providing the greatest signal. The touch-screen logic also determines which row was being excited when the greatest signal was received, and returns the numeric value of that row as the Y coordinate of the touch point.

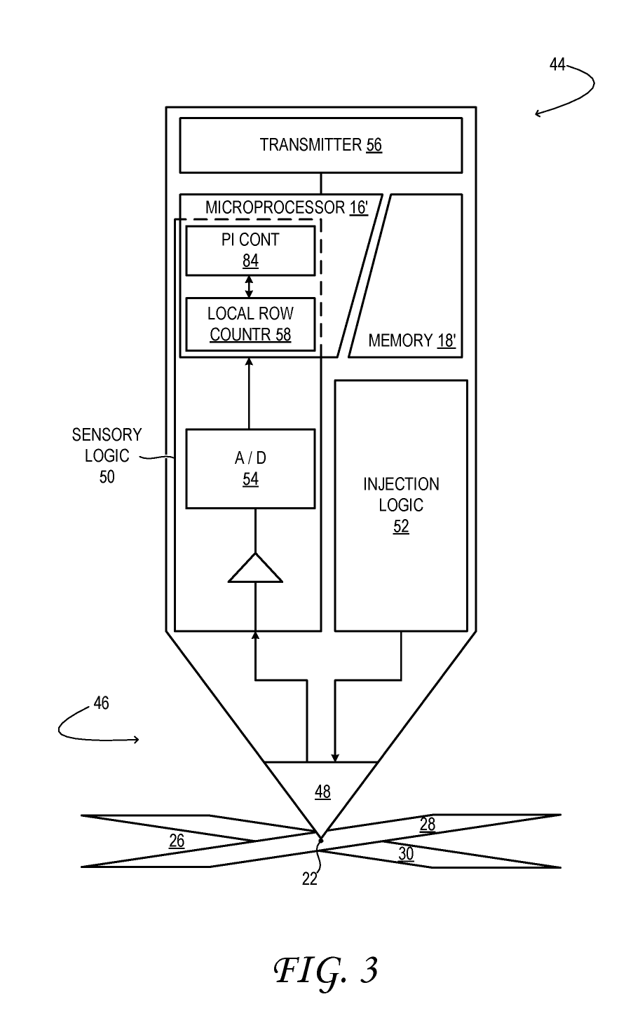

In some examples, a passive stylus having a tip of relatively high dielectric-constant material may be used in lieu of the user's fingertip to capacitively couple row and column electrodes under the touch point. A passive stylus may provide better touch accuracy than the fingertip, and may prevent smudging of the display by the fingertip. Instead of a passive stylus, however, touch-screen display device 10 may be associated with an active stylus 44, as shown in FIG. 3 in one example embodiment.

Active stylus 44 provides advantages over and beyond those of a passive stylus. For instance, the tip 46 of the active stylus may be very small in comparison to a fingertip. The smaller size of the tip allows the user to more precisely position the touch point on the touch screen. Moreover, the active stylus supports a faster and more accurate mode of touch sensing, as described further below.

Active stylus 44 includes a probe electrode 48 at tip 46. The probe electrode is operatively coupled to associated sensory logic 50 and injection logic 52. The sensory and injection logic are operatively coupled to, and may be embodied partially within, microprocessor 16′. Configured for digital signal processing (DSP), microprocessor 16′ is operatively coupled to associated computer memory 18′, as described further below. Sensory logic 50 includes linear analog componentry configured to maintain the probe electrode 48 at a constant voltage and convert any current into or out of the probe electrode 48 into a proportional current-sense voltage. The sensory logic includes an analog-to-digital (A/D) converter 54 that converts the current-sense voltage into digital data to facilitate subsequent processing. In one embodiment, the current-sense voltage may have bandwidth of approximately 100 kHz, and may be A/D-converted at a sampling rate of 1 million bits per second (Mbit/s).

Instead of capacitively coupling row and column electrodes of touch screen 12 via a dielectric, sensory logic 50 of active stylus 44 senses the arrival of an excitation pulse from row electrode 28, beneath (i.e., adjacent) touch point 22, and in response, injects charge into column electrode 30, also beneath the touch point 22. To this end, the active stylus 44 includes injection logic 52 associated with the probe electrode 48 and configured to control charge injection from the probe electrode 48 to the column electrode directly beneath (i.e., adjacent) the probe electrode. The injected charge appears, to column-sense logic 36 of the touch screen, similar to an electrostatic pulse delivered via capacitive coupling of the column electrode 30 to an energized row electrode 28 intersecting at touch point 22. In some embodiments, accordingly, the touch-screen logic is not limited to touch-screen display device 10, but extends also to the active stylus.

In some embodiments, sensory logic 50 and injection logic 52 are active during non-overlapping time windows of each touch-sensing frame, so that charge injection and charge sensing may be enacted at the same probe electrode 48. In this embodiment, touch-screen logic 32 excites the series of row electrodes 28 during the time window in which the sensory logic is active, but suspends row excitation during the time window in which the active stylus 44 may inject charge. This strategy provides an additional advantage, in that it enables touch-screen logic 32 to distinguish touch points effected by active stylus 44 from touch points effected by a fingertip or palm. If column-sense logic 36 detects charge from a column electrode 30 during the charge-injection time window of the active stylus 44 (when none of the row electrodes 28 are excited), then touch point 22 detected must be a touch point of the active stylus. However, if the column-sense logic detects charge during the charge-sensing window of the active stylus (when row electrodes 28 are being excited), then the touch point detected may be a touch point of a fingertip, hand, or passive stylus, for example.

Active sensing followed by charge injection enables a touch point 22 of a very small area to be located precisely, and without requiring long integration times that would increase the latency of touch sensing. For example, when receiving the signal from row electrode 28, the active stylus 44 may inject a charge pulse with amplitude proportional to the received signal strength. Thus, touch sensor 56 may receive the electrostatic signal from active stylus 44 and calculate the Y coordinate, which may be the row providing the greatest signal from the active stylus, or a function of the signals received at that row and adjacent rows. Nevertheless, this approach introduces various challenges. The major challenge is that the sensory logic 50 and injection logic 52 must operate simultaneously. Accordingly, probe electrode 48 may operate in full-duplex mode. Various methods for example, code division or frequency division multiple access—may be applied to cancel the strong interference at the receiving direction from the transmitting direction. The touch sensor may be required to receive two signals simultaneously (one from the row electrode 28, and the other from the stylus probe electrode 48). The system may also work by time-division, but at a cost in available integration time.

One solution to the above problem requires active stylus 44 to assume a more active role in determining the touch point coordinates. In the illustrated embodiment, sensory logic 50 of the active stylus 44 includes a local row counter 58, which is maintained in synchronization with row counter 38 (hereinafter, the remote row counter) of touch-screen logic 32. This feature gives the active stylus and the touch screen a shared sense of time, but without being wired together. In some embodiments, the local row counter 58 may be embodied as discrete hardware—e.g., a clocked register having a series of interconnected flip flops as described above. In other embodiments, the local row counter 58 may be embodied as a register within microprocessor 16′ of the touch-screen logic, or as a data structure held in computer memory 18′ associated with microprocessor 16′.

When probe electrode 48 touches contactable display surface 26 of touch screen 12, sensory logic 50 receives a waveform that lasts as long as the touch is maintained. The waveform acquires maximum amplitude at the moment in time when row electrode 28, directly beneath (i.e., adjacent) the probe electrode 48, has been energized. Sensory logic 50 is configured to sample the waveform at each increment of the local row counter 58 and determine when the maximum amplitude was sensed. This determination can be made once per frame, for example.

Because active stylus 44 and touch screen 12 enjoy a shared sense of timing (having synchronized row counters 38), the local row-counter 58 state at maximum sensed amplitude reports directly on the row coordinate—i.e., the Y coordinate—of touch point 22. In order to make use of this information, the Y coordinate must be communicated back to touch-screen logic 32. To this end, the active stylus includes communication componentry configured to wirelessly communicate the computed row coordinate to row-sense logic of the touch screen. This disclosure embraces various modes of communicating data, including the Y coordinate, from the active stylus to the touch screen.

The foregoing description of active stylus 44 is not intended to be limiting in any sense, for numerous variations, extensions, and omissions are also envisaged. For instance, a different type of active stylus may be configured to transmit charge pulses, but without the sensory logic referenced above. In still other examples, where some positioning uncertainty can be tolerated, a passive stylus may be used.

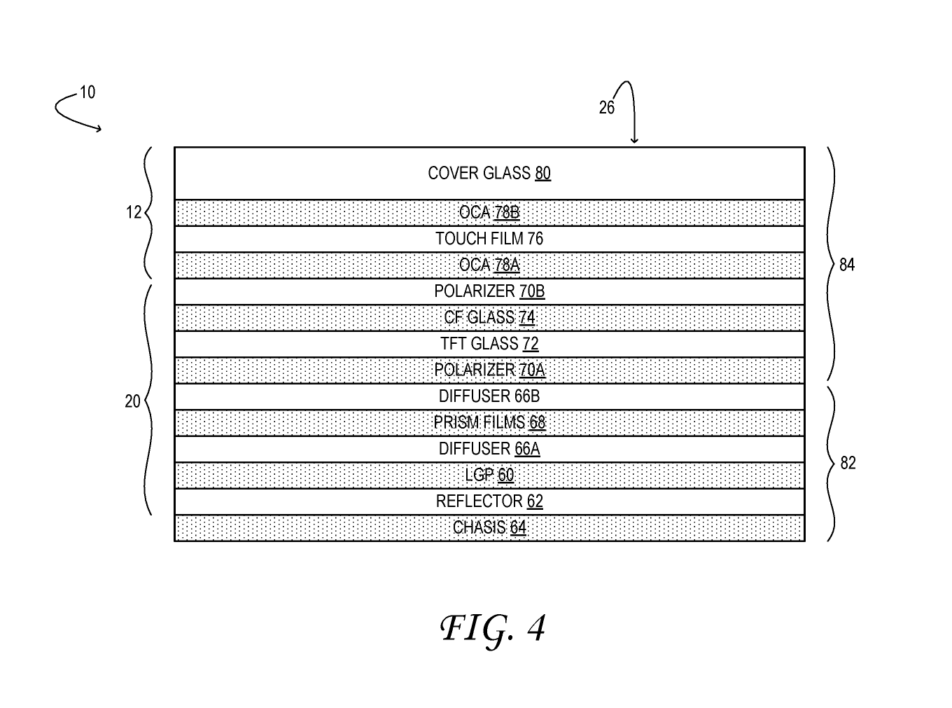

FIG. 4 is a schematic representation of touch-screen display device 10 as a series of stacked layers comprising touch screen 12 and display 20. In the illustrated example, the display is an LCD display. Backlighting for the display originates in lightguide plate (LGP) 60. The backlighting is directed toward diffuser 66A via reflector 62, which is coupled to chassis 64. The emission cone of the light is broadened by diffusers 66A and 66B. A series of prismatic films 68 is provided between the diffusers. From this point, suitably diffuse light passes into polarizer 70A, which selects light of a desired polarization state for entry into thin-film transistor (TFT) glass 72. The TFT glass supports a nematic liquid-crystal layer capable of selectively rotating the plane of polarization in response to external bias applied to the individual light-releasing pixel elements of the TFT glass. The light then passes through color-filter (CF) glass 74 having an array of CF elements in registry with the pixel elements of the TFT glass, and then through a second polarizer 70B, where light of the undesired polarization state is blocked. The second polarizer is bonded to touch film 76 by a layer of optically clear adhesive (OCA) 78A, and a second layer of OCA 78B bonds the touch film to cover glass 80. The cover glass may be between 0.3 and 0.9 mm, in some examples. Hereinafter, diffuser 66B and components arranged behind it are identified as emissive structure 82, while layers arranged in front of diffuser 66B are identified as refractive layers 84. The thickness of the refractive layers may be between 0.7 and 1.3 mm, in some examples.

As noted above, the problem addressed herein is the optical parallax that a touch-screen display device user experiences on sighting the tip of a stylus on the contactable display surface of a touch screen. In general, the positioning error due to the optical parallax depends on the vantage point from which the stylus tip is sighted; it increases with increasing distance between the light-emissive structure and the contactable front surface of the touch screen—i.e., the thickness of refractive layers 84 in FIG. 4.

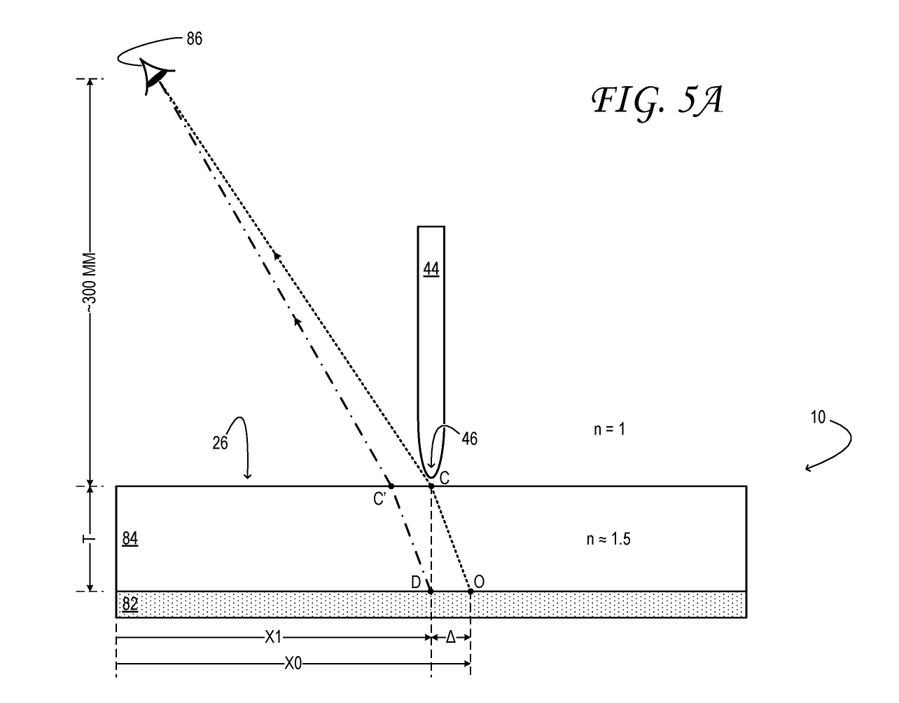

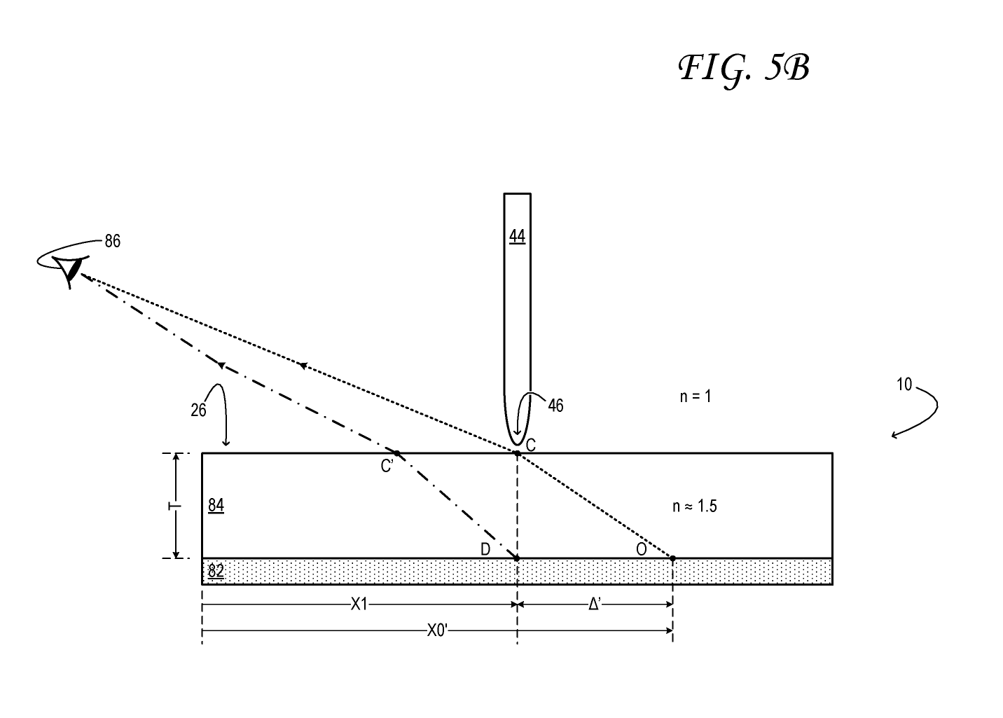

FIGS. 5A and 5B illustrate, in simplified form, the geometric basis of positioning error due to optical parallax on a touch-screen display device 10. Referring first to FIG. 5A, the user determines at the outset a desired point of contact of stylus tip 46 with contactable display surface 26 based on the display image presented on display 20. In a non-limiting scenario, the user may be assumed to target an existing virtual ink mark displayed at coordinate X0 along the contactable display surface. The light from this ink mark is diffused from the locus labeled O in FIG. 5A. It reaches the user's pupil 86 along the dotted ray, which is refracted as it passes out of the refractive layers 84 of the display stack. Although the drawing shows a single refraction event when the light ray exits the refractive layers, this aspect is a simplification, for the layers themselves may have different refractive indices, and give rise to sequence of refractions of the exiting ray. Based on the angle of the light received into the user's pupil, the user perceives that the tip of the stylus should contact the surface at the point labeled C. However, without correction, when the tip is put down on C, the touch-sensing logic returns a coordinate X1, which differs from X0 by an amount Δ. If the touch-screen display device is configured to form a new ink mark at the coordinate X1 received from the touch-sensing logic, the new ink mark will originate at the point labeled D, and will reach the user's pupil along the dot-dashed ray, appearing to originate at C′. Clearly the point of contact and the origin of the new ink mark are not coincident, as the user expects them to be. In FIG. 5B, the analysis above is repeated for a more glancing angle of observation of the stylus tip. The error in positioning the stylus tip at the sighted coordinate X0′ has now increased to Δ′. In general, the positioning error is larger for more glancing angles of observation and vanishes at normal observation.

Making the thickness T as small as possible—by using thinner cover glass 80, a thinner touch sensor, etc.—will reduce the error amount Δ. However, there is a practical lower limit to the thickness of the display stack due to manufacturing constraints and the need for a mechanically stable and robust contactable surface.

If the user's pupillary positions are known relative to the display coordinates, then the parallax error can be estimated and corrected by appropriate adjustment of the sensed normal coordinate X1. The quantitative estimate d correction Δ is based on the geometry and refractive indices of the display stack, the location of stylus tip 46 on contactable display surface 26, and the vantage point from which the stylus tip is sighted. In the scenario illustrated in FIG. 5, the corrected coordinates responsive to user touch at point C are X1+Δ, which yields the expected coordinate X0. Although the drawing illustrates the effect of parallax error only on one coordinate X of the touch point, analysis for the orthogonal coordinate Y follows analogously.

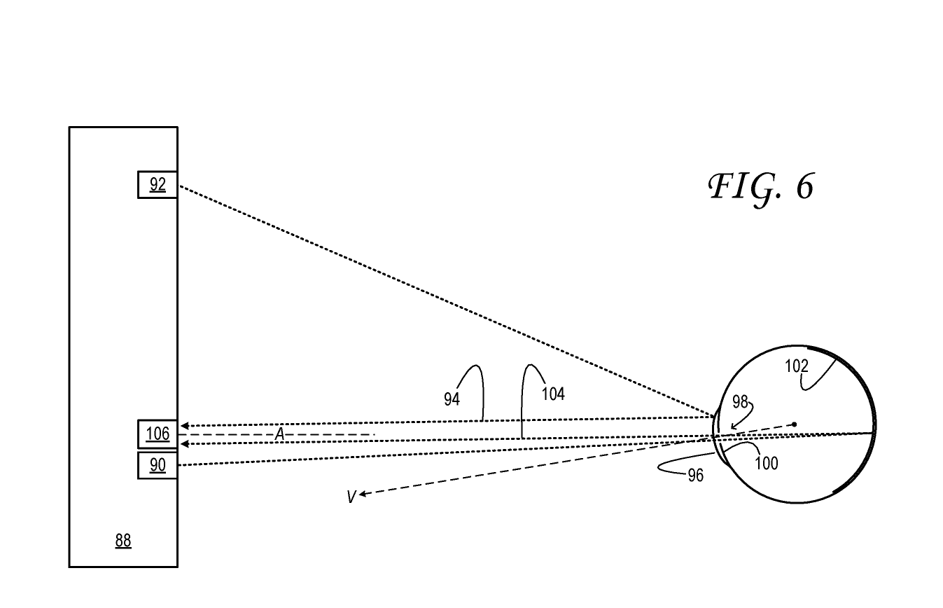

In order to operationally determine the user's vantage point, touch-screen display device 10 of FIG. 1 includes a user-facing camera 88 configured to image the user's pupils, eyes, face, or head in quasireal time. As shown in FIG. 6, user-facing camera 88 includes an on-axis lamp 90 and an off-axis lamp 92. Each lamp may comprise a light-emitting diode (LED) or diode laser, for example, which emits IR or NIR illumination in a high-sensitivity wavelength band of the user-facing camera. The terms ‘on-axis’ and ‘off-axis’ refer to the direction of illumination of the eye with respect to the optical axis A of the user-facing camera. On- and off-axis illumination may serve different purposes with respect to pupil estimation. Off-axis illumination may create a specular glint 94 that reflects from the cornea 96 of the user's eye. Off-axis illumination may also be used to illuminate the eye for a ‘dark pupil’ effect, where pupil 98 appears darker than the surrounding iris 100. By contrast, on-axis illumination from an IR or NIR source may be used to create a ‘bright pupil’ effect, where the pupil appears brighter than the surrounding iris. More specifically, IR or NIR illumination from on-axis lamp 90 may illuminate the retroreflective tissue of the retina 102 of the eye, which reflects the illumination back through the pupil, forming a bright image 104 of the pupil, which is imaged through objective lens 106.

Returning briefly to FIG. 1, digital image data from user-facing camera 88 may be conveyed to pupil-estimation logic 108. There, the image data may be processed to resolve such features as the pupil center, pupil outline, and/or one or more specular glints from the cornea. The locations of such features in the image data may be used as input parameters in a model—e.g., a polynomial model—that relates feature position to the vantage vector V, a line passing through the user and through the point of user contact. In this manner, the pupil-estimation logic may be configured to estimate the vantage vector. In other embodiments, the user-facing camera and associated pupil-estimation logic may be configured to resolve the user's eyes, face, or head, rather than the pupils. Pupil positions may be estimated from the eye, face, or head positions based on a suitable model. The model may be assisted by face-recognition logic, which identifies the locus of the user's face in an image of the head. In these and other embodiments, the amount of adjustment applied to the touch coordinates may vary across the display, as a function of the changing vantage vector.

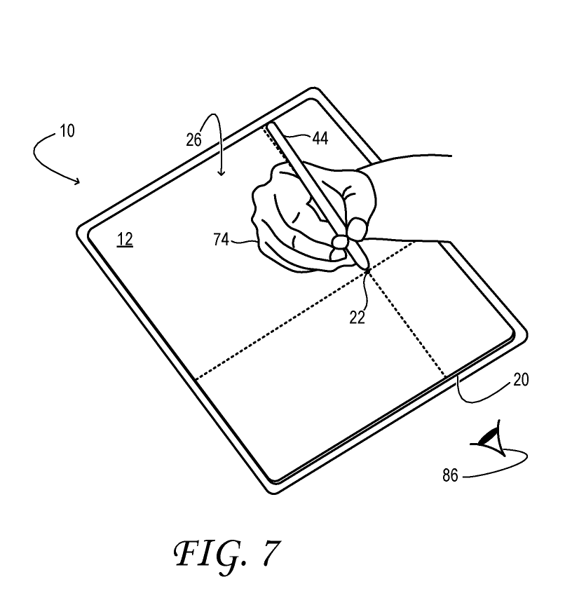

Despite the benefit of accurate estimation of the pupil positions, user-facing camera 88 may be omitted in some embodiments. Pupil-estimation logic 108 may then estimate the pupil positions based on a series of heuristics. For example, the user may be expected to view the display screen from a side opposite to the side that the operating system of computer 14 renders as the top. In addition, the palm location relative to the tip location can be used to predict the likely vantage point of the user. For example, the user may be expected to view the display screen from the side of the tip which is opposite to the side where the palm is located. This scenario is illustrated in FIG. 7.

In some embodiments, touch-screen display device 10 may include non-user imaging sensory components to increase the reliability of the heuristic analysis outlined above. The components are configured to enable the touch-screen display device to reckon its position and orientation. In the embodiment shown in FIG. 1, the sensory components include an inertial measurement unit (IMU) 110 and a magnetometer 112. The IMU may comprise a multi-axis accelerometer and a multi-axis gyroscope for detailed translation and rotation detection. The magnetometer may be configured to sense the absolute orientation of the touch-screen display device. Alternatively, or in addition, the touch-screen display device may include one or more world-facing cameras 114. Downstream image-processing in pupil-estimation logic 108 may be used to recognize real objects imaged by the world-facing cameras, and thereby allow the device to reckon its position and orientation.

In some examples, the tilt of touch-screen display device 10 may be ascertained via the accelerometer of IMU 110 and/or image data from world-facing camera 43. With the same grip on a touch-screen display device 10, the user in different postures will have different head positions, depending on whether she is seated, standing, or lying down. The georelative orientation of the touch-screen display device may narrow down the user's posture, which in turn will enable a more accurate estimate of the vantage vector. Such data may provide a high-confidence indicator of the direction in which the user is located, but does not indicate how far away the eyes are. To provide this data, an estimate of this metric based on a statistical model may be used. Alternatively, a calibration routine (vide infra) may be enacted separately for each user of the touch-screen display device, to further increase the pupil-estimation accuracy.

Continuing now in FIG. 1, user-pointer logic 116 is configured to compute adjusted coordinates of contactable display surface 26 and load a user-pointer data structure 118 of touch-sensing display device 10 with the adjusted coordinates. The user-pointer data structure stores and returns the coordinates (X, Y) of the user pointer e.g., ‘pen’ or ‘mouse’ coordinates. The adjusted coordinates are coordinates shifted from the normal coordinates based on the estimated vantage vector. Display logic 120 is configured to render a visible feature on the contactable display surface at the adjusted coordinates.

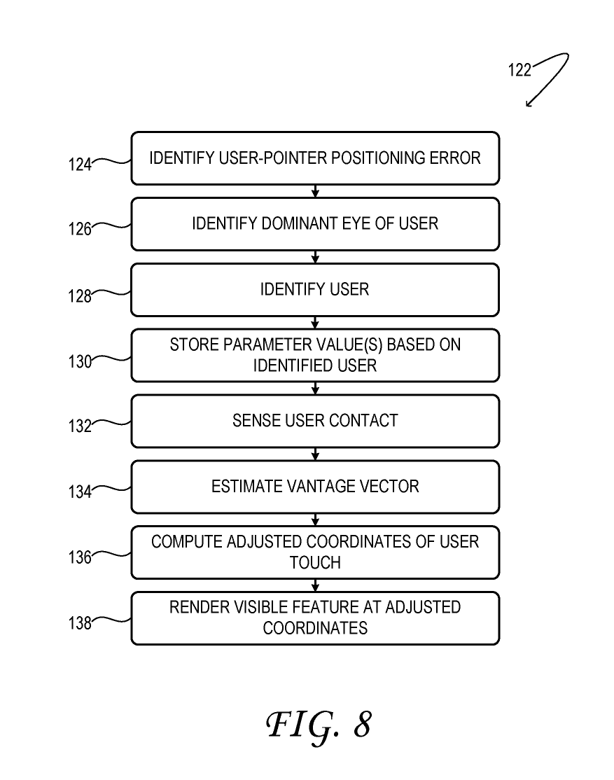

FIG. 8 illustrates an example user-pointer adjustment method 122. The method may be enacted in a touch-sensing display system as described above—i.e., a display system having a contactable display surface as an outer surface of a display stack with a light-releasing pixel surface set behind the contactable display surface.

At 124 of method 122 a user-pointer positioning error is identified heuristically, based on the user's interaction with the touch screen. In some examples, the user-pointer positioning error may include error in connecting inferentially connectable line segments drawn on the contactable display surface. In a handwriting recognition app, for instance, a user that has just drawn the two vertical lines of the capital letter ‘H’ may attempt to target but miss the first vertical line in attempting to draw the horizontal crossbar of the ‘H’. This type of error can be recognized by the user-pointer logic. Analogous scenarios are envisaged for users attempting to cross a ‘T’ in the handwriting recognition app, or to press a radio button or check a checkbox of a graphical user interface (GUI) presented on the touch-screen display.

At 126 of method 122, the dominant eye of the user is identified. In some examples, identifying the dominant eye may include identifying based on the user-pointer positioning error (at 124). For instance, the magnitude of the user-pointer positioning error may be greater in regions of the display that are farther from the dominant eye. In some examples, identifying the dominant eye may include presenting on the display a user-interface element specifically configured to test which eye is dominant. Presented during a calibration phase of the touch-sensitive display system, the user-interface element may include a graphic that the user is obliged to view. The user-interface element may further include and a query element that queries the user's perception of the graphic. The user's response received via the query element enables the user-pointer logic to determine which eye is dominant.

At 128 a user of the touch-sensing display system is identified from among a plurality of potential users of the touch-sensing display system. The user may be identified based on the user profile currently being accessed via the operating system of the touch-sensing display device. At 130 a parameter value 131 based on the identified user is stored by the pupil-estimation logic.

At 132 various forms of user contact on the contactable display surface of the touch-sensing display system are sensed by the touch-sensing logic. The user contact may include contact with the user's finger or stylus, whether active or passive. At a minimum, the sensed user contact includes normal coordinates directly behind a point of user contact on the contactable display surface. In examples that include presentation of a UI element to determine which eye is dominant (at 126, above), the sensed user contact may include contact made in response to presentation of the afore-mentioned UI element. In some examples, the forms of user contact sensed at 132 may include the locus of palm contact on the contactable display surface.

At 134 a vantage vector pointing from a vantage point of the user and through the point of user contact is estimated_{—} In embodiments in which the dominant eye of the user is identified, the estimated vantage vector may be a vector that passes specifically through the dominant eye of the user. In other embodiments, the estimated vantage vector may pass between the identified or inferred location of the eyes, interocular axis, or head of the user.

In some embodiments, the vantage vector may be estimated heuristically, based on the region of the user contact on the contactable display surface. If the sensed user contact includes a locus of user palm contact, then the vantage vector may be estimated based on the locus of user palm contact. In systems having an orientation sensor responsive to an orientation of the contactable display surface, then the vantage vector may be estimated based on output of the orientation sensor. In systems having a camera, the pupil-estimation logic may be configured to estimate the vantage vector based on output of the camera. As noted above, the camera may be a user-facing camera that actually images the user's eyes or head, or, a world-facing camera providing image data from which the touch-sensing display device can reckon its position and orientation.

In embodiments in which a user-pointer positioning error is identified (at 124) the vantage vector may be estimated further based on the user-pointer positioning error. In embodiments that include identification of the user (at 128), the vantage vector may be estimated further based on the identity of the user. In embodiments in which a parameter value based on the identified user is stored (at 130), the vantage vector may be estimated further based on the stored parameter value.

In one example, the pupil-estimation logic may provide a larger eye-to-screen distance for adult users than for children. In other examples, different users may tend to hold the touch-screen display device differently. One user may use a two handed grip to hold a tablet in front of himself, with arms resting on a table; a different user may use the same grip to hold the device on his lap, providing a lower angle of observation (relative to the display surface normal). The pupil-estimation logic may intuit these differences based on the user identity. In cases where there is no stored profile linked to the current user, generic metrics from a generic profile may be applied.

At 136 adjusted coordinates of user touch on the contactable display surface are computed. The adjusted coordinates are coordinates shifted from the normal coordinates based on the estimated vantage vector. In some embodiments, the adjusted coordinates are coordinates of intersection of the pixel surface and the estimated vantage vector upon refraction through the display layer. In embodiments in which the user-pointer positioning error is determined, the adjusted coordinates may be coordinates chosen to null the positioning error.

At 138 a visible feature on the contactable display surface is rendered at the adjusted coordinates. The visible feature may include an ink mark representing some portion of drawing object, and/or a cursor element of a graphical user interface.

No aspect of the description above should be interpreted in a limiting sense, for numerous variations and departures are contemplated as well. For instance, although the computed positioning error Δ may be used to offset user-pointer coordinates, as described above, it may alternatively be applied in reverse to the coordinates of any object presented on the display.

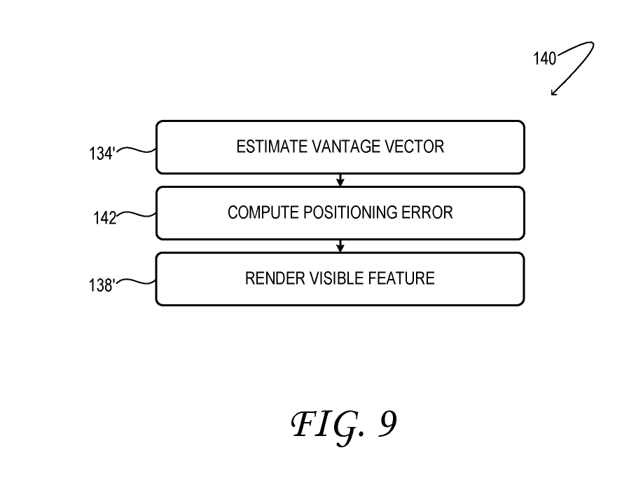

Furthermore, at least some correction to the normal coordinates sensed by the touch-screen logic may be enacted prior to contact of the stylus tip, or without detailed knowledge of the point of contact. In some embodiments, a vantage vector originating at the user's pupils and terminating at any point on the contactable display surface (e.g., the current cursor location, the location of a newly rendered graphic, the midpoint of the display screen, etc.) may be used in lieu of the vantage vector described above. In general, an observed, estimated or predicted pupil position relative to the display may be used to preemptively compute and correct for positioning error Δ in all regions of the touch-screen. FIG. 9 illustrates a method 140 that embraces this approach as well as that of the previous method.

At 134′ of method 140, a vantage vector of the user is estimated, substantially as described hereinabove. The vantage vector is a vector pointing from a vantage point of the user and through an observable point on the contactable display surface, which may or may not be a point that the user has already touched with the stylus.

At 142 the positioning error due to parallax at the observable point on the contactable display surface is computed based on the estimated vantage vector. Naturally, vantage vectors of different angles may be estimated for different observable points, points of contact, etc., leading to different computed positioning errors and adjusted coordinates. With reference again to FIGS. 5A and 5B, the positioning error is the distance travelled laterally, across the display stack, by a ray originating at the light-releasing pixel surface and refracting out from the contactable display surface at the observable point, before continuing along the vantage vector. In effect, the positioning error equates to the length of projection of the dotted ray inside refractive layers 84 in FIGS. 5A and 5B, in the plane of contactable display surface 26.

At 138′ a visible feature is rendered on the contactable display surface at coordinates adjusted according to the positioning error. Typically the visible feature may be a cursor or new ink mark deposited on the display surface in response to user touch. For example, when a stylus contacts a point on the contactable display surface, a pixel offset from the point of contact by the positioning error is used to render an ink mark to avoid the parallax error that would occur if the pixel directly behind the point of contact were used to render the ink mark. In some implementations, this effect can be achieved by shifting the touch sense locations relative to the display pixel locations across the entirety of the display. Conversely, it is also envisaged that a preexisting display image may be shifted and/or transformed based on the computed positioning error, so that subsequent touch points are accurately registered to the display image.

As noted above, the methods and processes described herein may be tied to a computer system of one or more computing devices. In particular, such methods and processes may be implemented as a computer system-application program or service, an application-programming interface (API), a library, and/or other computer system-program product.

FIG. 1 schematically shows a non-limiting embodiment of a computer system, in the form of touch-screen display device 10, that can enact the methods and processes described above. Device 10 includes a processor 16 and an electronic memory 18. Device 10 includes a display 20, an input subsystem in the form of touch screen 12, and may include a communication subsystem and other components not shown in FIG. 1.

Processor 16 includes one or more physical devices configured to execute instructions. For example, the processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Processor 16 may be one of a plurality of processors configured to execute software instructions. Additionally or alternatively, the processor may include one or more hardware or firmware logic machines configured to execute hardware or firmware instructions. Processors of device 10 may be single-core or multi-core, and the instructions executed thereon may be configured for sequential, parallel, and/or distributed processing. Individual components of the computer system optionally may be distributed among two or more separate devices, which may be remotely located and/or configured for coordinated processing. Aspects of the computer system may be virtualized and executed by remotely accessible, networked computing devices configured in a cloud-computing configuration.

Electronic memory 18 includes one or more physical devices configured to hold instructions executable by processor 16 to implement the methods and processes described herein. When such methods and processes are implemented, the state of electronic memory 18 may be transformed—e.g., to hold different data.

Electronic memory 18 may include removable and/or built-in devices. Electronic memory 18 may include semiconductor memory (e.g., RAM, EPROM, EEPROM, etc.), and/or magnetic memory (e.g., hard-disk drive, floppy-disk drive, tape drive, MRAM, etc.), among others. Electronic memory 18 may include volatile, nonvolatile, dynamic, static, read/write, read-only, random-access, sequential-access, location-addressable, file-addressable, and/or content-addressable devices.

It will be appreciated that electronic memory 18 includes one or more physical devices. However, aspects of the instructions described herein alternatively may be propagated by a communication medium (e.g., an electromagnetic signal, an optical signal, etc.) that is not held by a physical device for a finite duration.

Aspects of processor 16 and electronic memory 18 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms ‘module,’ ‘program,’ and ‘engine’ may be used to describe an aspect of device 10 implemented to perform a particular function. In some cases, a module, program, or engine may be instantiated via processor 16 executing instructions held by electronic memory 18. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ program,' and ‘engine’ may encompass individual or groups of executable files, data files, libraries, drivers, scripts, database records, etc.

It will be appreciated that a ‘service’, as used herein, is an application program executable across multiple user sessions. A service may be available to one or more system components, programs, and/or other services. In some implementations, a service may run on one or more server-computing devices.

Display 20 may be used to present a visual representation of data held by electronic memory 18. This visual representation may take the form of a graphical user interface (GUI). As the herein described methods and processes change the data held by the storage machine, and thus transform the state of the storage machine, the state of display 20 may likewise be transformed to visually represent changes in the underlying data. Display 20 may include one or more near-eye display devices utilizing virtually any type of technology. Such near-eye display devices may be combined with processor 16 and/or electronic memory 18 in a shared enclosure, or such near-eye display devices may be peripheral near-eye display devices.

In addition to touch screen 12, the input subsystem may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

A communication subsystem may be configured to communicatively couple device 10 with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow device 10 to send and/or receive messages to and/or from other devices via a network such as the Internet.

One aspect of this disclosure is directed to a touch-sensing display system comprising a contactable display surface operatively coupled to touch-screen, pupil-estimation, user-pointer, and display logic. The touch-screen logic is configured to sense normal coordinates directly behind a point of user contact on the contactable display surface. The pupil-estimation logic is configured to estimate a vantage vector pointing from a vantage point of the user and through the point of user contact. The user-pointer logic is configured to compute adjusted coordinates of the contactable display surface, the adjusted coordinates being shifted from the normal coordinates based on the estimated vantage vector. The display logic is configured to render a visible feature on the contactable display surface at the adjusted coordinates.

In some implementations, the touch-sensing display system further comprises an active stylus. In some implementations, the touch-screen logic is arranged in the active stylus. In some implementations, the contactable display surface is an outer surface of a display stack having a light-releasing pixel surface set behind the contactable display surface, and the adjusted coordinates are coordinates of intersection of the pixel surface and the estimated vantage vector upon refraction through the display stack. In some implementations, the pupil-estimation logic is configured to estimate the vantage vector pointing from a dominant eye of the user through the point of user contact. In some implementations, the pupil-estimation logic is configured to estimate the vantage vector heuristically, based on the region of the user contact on the contactable display surface. In some implementations, the user contact includes a locus of user palm contact, and the pupil-estimation logic is configured to estimate the vantage vector based on the locus of user palm contact. In some implementations, the touch-sensing display system further comprises an orientation sensor to measure an orientation of the contactable display surface, and the pupil-estimation logic is configured to estimate the vantage vector based on output of the orientation sensor. In some implementations, the touch-sensing display system further comprises a camera, wherein the pupil-estimation logic is configured to estimate the vantage vector based on output of the camera. In some implementations, the visible feature includes a virtual ink mark. In some implementations, the visible feature includes a cursor.

Another aspect of this disclosure is directed to a method enacted in a touch-sensing display system having a contactable display surface as an outer surface of a display stack, with a light-releasing pixel surface set behind the contactable display surface. The method comprises estimating a vantage vector pointing from a vantage point of the user and through an observable point on the contactable display surface; computing a positioning error due to parallax at the observable point, the positioning error being a distance travelled laterally, across the display stack, by a ray originating at the light-releasing pixel surface and refracting out from the contactable display surface at the observable point before continuing along the vantage vector; and rendering a visible feature on the contactable display surface at coordinates adjusted according to the positioning error.

In some implementations, the method further comprises sensing normal coordinates directly behind the point of user contact. In some implementations, the method further comprises identifying a user of the touch-sensing display system, wherein the vantage vector is estimated based on an identity of the user. In some implementations, the method further comprises storing a parameter value influencing estimation of the vantage vector for each of a plurality of users of the touch-sensing display system, and retrieving the parameter value for the identified user. In some implementations, the method further comprises identifying a dominant eye of the user, wherein the estimated vantage vector passes through the dominant eye. In some implementations, identifying the dominant eye includes identifying based on the positioning error. In some implementations, identifying the dominant eye includes presenting a user-interface element on the contactable display, and further comprising sensing user contact made in response to presentation of the user-interface element.

Another aspect of this disclosure is directed to a user-pointer adjustment method enacted in a touch-sensing display system having a contactable display surface. The method comprises sensing normal coordinates directly behind a point of user contact on the contactable display surface; identifying a user-pointer positioning error; estimating a vantage vector pointing from a vantage point of the user and through the point of user contact, responsive to the user-pointer positioning error; computing adjusted coordinates on the contactable display surface, the adjusted coordinates being shifted from the normal coordinates based on the estimated vantage vector; and rendering a visible feature on the contactable display surface at the adjusted coordinates.

In some implementations, the user-pointer positioning error includes error in connecting inferentially connectable line segments drawn on the contactable display surface.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A touch-sensing display system comprising:
a contactable display surface;
touch-screen logic configured to sense normal coordinates directly behind a point of user contact on the contactable display surface;
pupil-estimation logic configured to estimate a vantage vector pointing from a vantage point of the user and through the point of user contact;
user-pointer logic configured to compute adjusted coordinates of the contactable display surface, the adjusted coordinates being shifted from the normal coordinates based on the estimated vantage vector; and
display logic configured to render a visible feature on the contactable display surface at the adjusted coordinates.

2. The touch-sensing display system of claim 1 further comprising an active stylus.

3. The touch-sensing display system of claim 2 wherein the touch-screen logic is arranged in the active stylus.

4. The touch-sensing display system of claim 1 wherein the contactable display surface is an outer surface of a display stack having a light-releasing pixel surface set behind the contactable display surface, and wherein the adjusted coordinates are coordinates of intersection of the pixel surface and the estimated vantage vector upon refraction through the display stack.

5. The touch-sensing display system of claim 1 wherein the pupil-estimation logic is configured to estimate the vantage vector pointing from a dominant eye of the user through the point of user contact.

6. The touch-sensing display system of claim 1 wherein the pupil-estimation logic is configured to estimate the vantage vector heuristically, based on the region of the user contact on the contactable display surface.

7. The touch-sensing display system of claim 1 wherein the user contact includes a locus of user palm contact, and wherein the pupil-estimation logic is configured to estimate the vantage vector based on the locus of user palm contact.

8. The touch-sensing display system of claim 1 further comprising an orientation sensor to measure an orientation of the contactable display surface, wherein the pupil-estimation logic is configured to estimate the vantage vector based on output of the orientation sensor.

9. The touch-sensing display system of claim 1 further comprising a camera, wherein the pupil-estimation logic is configured to estimate the vantage vector based on output of the camera.

10. The touch-sensing display system of claim 1 wherein the visible feature includes a virtual ink mark.

11. The touch-sensing display system of claim 1 wherein the visible feature includes a cursor.

12. Enacted in a touch-sensing display system having a contactable display surface as an outer surface of a display stack with a light-releasing pixel surface set behind the contactable display surface, a method comprising:
estimating a vantage vector pointing from a vantage point of the user and through an observable point on the contactable display surface;
computing a positioning error due to parallax at the observable point, the positioning error being a distance travelled laterally, across the display stack, by a ray originating at the light-releasing pixel surface and refracting out from the contactable display surface at the observable point before continuing along the vantage vector; and
rendering a visible feature on the contactable display surface at coordinates adjusted according to the positioning error.

13. The method of claim 12 further comprising sensing normal coordinates directly behind the point of user contact.

14. The method of claim 12 further comprising identifying a user of the touch-sensing display system, wherein the vantage vector is estimated based on an identity of the user.

15. The method of claim 14 further comprising storing a parameter value influencing estimation of the vantage vector for each of a plurality of users of the touch-sensing display system, and retrieving the parameter value for the identified user.

16. The method of claim 12 further comprising identifying a dominant eye of the user, wherein the estimated vantage vector passes through the dominant eye.

17. The method of claim 12 wherein identifying the dominant eye includes identifying based on the positioning error.

18. The method of claim 12 wherein identifying the dominant eye includes presenting a user-interface element on the contactable display, and further comprising sensing user contact made in response to presentation of the user-interface element.

19. Enacted in a touch-sensing display system having a contactable display surface, a user-pointer adjustment method comprising:
sensing normal coordinates directly behind a point of user contact on the contactable display surface;
identifying a user-pointer positioning error;
estimating a vantage vector pointing from a vantage point of the user and through the point of user contact, responsive to the user-pointer positioning error;
computing adjusted coordinates on the contactable display surface, the adjusted coordinates being shifted from the normal coordinates based on the estimated vantage vector; and
rendering a visible feature on the contactable display surface at the adjusted coordinates.

20. The user-pointer adjustment method of claim 19 wherein the user-pointer positioning error includes error in connecting inferentially connectable line segments drawn on the contactable display surface.
